(19) United States
(12) Patent Application Publication
(10) Pub. No.: US 2016/0323227 A1
(43) Pub. Date: Nov. 3, 2016

(54) METHOD AND SYSTEM FOR PROVIDING A USER WITH AN INDICATION OF AN UNREAD E-MAIL COUNT ON A CLIENT DEVICE

(71) Applicant: YANDEX EUROPE AG, Luzern (CH)

(72) Inventors: Oleg Anatolievich AVDIENKOV, Moscow (RU); Alexey Andreevich DOTSENKO, Moscow (RU)

(21) Appl. No.: 15/109,247

(22) PCT Filed: Oct. 7, 2014
(86) PCT No.: PCT/IB14/65124

§ 371 Date: Jun. 30, 2016

(30) Foreign Application Priority Data
Mar. 27, 2014 (RU) 2014111625

(51) Int. Cl. H04L 12/58; G06F 3/0482; G06F 17/24; H04L 29/06

(52) U.S. Cl. CPC H04L 51/24; H04L 63/08; G06F 3/0482; G06F 17/24

(57) ABSTRACT

A computer-implemented method for providing a user with an indication of an unread e-mail count on a client device, the client device having a user interface, the user interface having an omnibox, the method comprising: receiving, by the client device from the user, the user being authenticated in an e-mail service on the client device, a trigger to display the unread e-mail count, the trigger having been entered into the omnibox; displaying the unread e-mail count in the omnibox.

### CROSS-REFERENCE

The present application claims convention priority to Russian Patent Application No. 2014111625, filed Mar. 27, 2014, entitled “A METHOD AND A SYSTEM FOR PROVIDING A USER WITH AN INDICATION OF AN UNREAD E-MAIL COUNT ON A CLIENT DEVICE” which is incorporated by reference herein in its entirety.

### FIELD

The present technology relates to computer-implemented method for processing e-mails, and specifically to a method and a system for providing a user with an indication of an unread e-mail count on a client device.

### BACKGROUND

Electronic data communications, particularly electronic mail (e-mail), is increasingly prevalent for both business and personal uses. E-mail services may be offered to users by e-mail service providers. Such businesses host a user's e-mail account providing the user with a mailbox.

There exist two major methods of implementation of e-mail clients.

One of them is Webmail (or web-based e-mail), that is an e-mail client implemented as a web application accessed via a web browser. Examples of webmail providers include Yandex Mail, AOL Mail, Gmail, Outlook.com, Yahoo! Mail, and others. As with any web application, webmail's main advantage over the use of a desktop e-mail client is the ability to send and receive e-mail anywhere from a web browser.

The second major method of implementation of e-mail clients is a locally installed mail user agent. Popular locally installed e-mail clients include Microsoft Outlook, Mozilla's Thunderbird, Eudora, and others.

One of popular services for users of many locally installed mail user agent is e-mail notifications. E-mail notifications permit to a user to know if they have unread messages. However, they do not permit to know how many unread messages are in a mail box, when the e-mail client is not opened. To know that, a user needs to open their e-mail client, or open in a web browser a web page of their e-mail service provider.

Many e-mail users have more than one e-mail account. Therefore, when using a web browser, a user has to visit all the web pages related to their e-mail accounts in order to get the number of unread messages, or they need to switch from their web browser to their locally installed mail user agent. This latter action can be difficult (if not impossible) if the user uses a computer where their user's e-mail client is not available (such as a public computer in an internet cafe or the like).

There is therefore a need for improvements of user experience in this field.

### SUMMARY

It is an object of the present technology to ameliorate at least some of the inconveniences present in the prior art.

In one aspect, implementations of the present technology provide a computer-implemented method for providing a user with an indication of an unread e-mail count on a client device, the client device having a user interface, the user interface having an omnibox, the method comprising: receiving, by the client device from the user, the user being authenticated in an e-mail service on the client device, a trigger to display the unread e-mail count, the trigger having been entered into the omnibox; and displaying the unread e-mail count in the omnibox.

In some implementations, the omnibox comprises an address bar.

In some implementations, the omnibox comprises a search bar.

In some implementations, the omnibox comprises a combined search and address bar.

In some implementations, the omnibox comprises: one of (i) the address bar, and (ii) the search bar, and (iii) the combined search and address bar; and a suggest menu in visual proximity to the respective one of the address bar, the search bar and the combined search and address bar. As a person skilled in the art would understand, the suggest menu can be a drop-down menu depending from the respective one of the address bar, the search bar and the combined search and address bar. However, the suggest menu can be any other type of menu, such as pop up menu, pop over menu, etc.

In some implementations, this method further comprises receiving from a server, prior to the displaying, an indication of the unread e-mail count. The receiving from a server, prior to the displaying, an indication of the unread e-mail count, can be effected by access by the client device to a file stored on the respective server hosting an e-mail service. This file can be a file in an XML or any suitable file format which contains unread e-mail count. However, receiving from the server an indication of the unread e-mail count can be effected by receiving of the unread e-mail count sent to the client device by respective server.

The receiving step can be repeated over time. As such, the method can further include, receiving a second indication of the unread e-mail count, the receiving of the second indication of the unread e-mail count being executed at a point of time after receiving the indication of the e-mail count and the second indication of the e-mail count being an updated e-mail count.

As a person skilled in the art would understand, the server can be a plurality of servers, and the receiving an indication of the unread e-mail count can be effected from more than one server. For illustrative purposes, as a non-limiting example, a respective unread e-mail count can be received by the client device from several servers of e-mail services providers, each respective unread e-mail count being associated with respective server, where the user is presently authenticated.

In some implementations of the present technology, the method further comprises, prior to the displaying, sending to the server the request for the unread e-mail count; and receiving, from the server, the indication of the unread e-mail count. The receiving step can be repeated over time. As such, the method can further include, receiving a second indication of the unread e-mail count, the receiving of the second indication of the unread e-mail count being executed at a point of time after receiving the indication of the e-mail count and the second indication of the e-mail count being an updated e-mail count. As a person skilled in the art would understand, the server can be a plurality of servers. As a non-limiting example, the user can have several e-mail accounts with several e-mail service providers. The request for the unread e-mail count can be sent by the client device to each respective server of several e-mail service providers, where the user is presently authenticated on the client device.

In some implementations, the displaying the unread e-mail count is effected in the suggest menu. As a non-limiting example, the displaying the unread e-mail count can be effected in the suggest menu along with one or several search suggests, links to previously visited web pages, and the like. As a non limiting example, the unread e-mail count can be displayed in close proximity to the suggest associated with respective e-mail service. As a person skilled in the art would understand, the displaying of the unread e-mail count can be displaying of more than one e-mail count.

In some implementations, displaying the unread e-mail count comprises displaying a graphical object representative of the unread e-mail count. In some implementations, the graphical object can be an envelop sign, a flag sign, or it can be implemented in any other shape. As a person skilled in the art would understand, there could be more than one graphical object displayed. As a non-limiting example, if the user is authenticated in three e-mail accounts, respectively three graphical objects of the same type can be displayed next to each respective unread e-mail count. For example, an image of a closed envelope can be displayed next to each unread count. In others implementations, a graphical object for each of the e-mail services can be different from the graphical objects of some or all of the other e-mail services. In some implementations, some or all graphical objects can be omitted. For example, some of the unread e-mail notifications can be displayed with the associated graphical objects and others can be displayed without a respective graphical object. Furthermore, the graphical objects can be omitted altogether.

In some implementations, the trigger to display the unread e-mail count comprises at least a portion of a word associated with the e-mail service. As a non-limiting example, trigger can comprise any character, for example letters “m”, “g”, and combinations of characters, for example “ma”, “mai”, “gmail” “i”, “in”, “inb”, “inbox”, “yahoo” “yandex”, “message”, “Nachrichten”, “ [symbol] ” and others. Combinations forming the trigger can consist of letters, numbers and other characters. Letters can be Latin, Cyrillic and others.

As person skilled in the art would understand, the user may have an intent to view the unread e-mail count and, as such, the user may deliberately enter a user-inputted string that the user knows will be recognized as the trigger to display the unread e-mail count into the omnibox. Alternatively, the user may not have the intent to get the unread e-mail count in the omnibox. In this case, depending on the content of the user-inputted string, the client device may still recognize characters entered into omnibox as the trigger to display the unread e-mail count. Both of such entries of characters (with or without the intent to have displayed the unread e-mail account), being recognized by the client device as the trigger to display the unread e-mail count, shall be considered to within the meaning of the term “trigger to display the unread e-mail count”.

How the recognition of characters entered into the omnibox as the trigger to display the unread e-mail count is executed is not particularly limited. For example, the computer usable information storage medium of the client device can store keywords which will be used for recognition of the user-inputted string as the trigger. Thus, if words “gmail” and “inbox” will be stored as keywords, the client device can recognize as the trigger to display an unread e-mail count these words as well as all the letters present in these words, or sequences of letters containing in these words. In addition or alternatively, the client device can use words or combinations of characters which are present in the path (such as a full URL or a portion thereof) to the mailbox previously visited by the user during the present or previous sessions of the web browser.

As a non-limitative illustrative example of one of the implementations, the user of the client device can be authenticated in two e-mail services on the client device, namely Rambler Mail and Yandex Mail. He is not presently on the web page of any of these e-mail services. However, a login cookie or another indication of the user's login credentials can be stored on the client device in association with the two e-mail services the user is logged into. The user starts typing a user-inputted string into omnibox of the user interface of the client device, such as an omnibox of a browser. Client device conducts analysis of the user-inputted string to determine if the user-inputted string can be deemed to be a trigger for displaying an unread e-mail count. If the client device recognizes the combination of characters as a trigger, it sends the request for the unread e-mail count to servers hosting user's e-mail accounts where the user is presently authenticated, that is servers hosting Rambler Mail and Yandex Mail e-mail services. Then, in response, the servers send and the client device receives respective unread e-mail counts from respective servers and displays respective one or more e-mail counts in the omnibox.

In other implementations, the client device sends to the server an indication that the user is authenticated in an e-mail service on the client device, and does not send to the server the request for the unread e-mail count. The server then sends a notification to the client device, containing the unread e-mail count. This sending can be done repeatedly, for example, at a certain interval (for example, each 5 minutes, each 15 minutes, each 1 minute, etc). As an alternative, the server can send the notification to the client device upon new message, destined to the user, arriving to the server. In those implementations, once a trigger to display the unread e-mail count is received from the user, the trigger being substantially similar as has been described above, the client device displays the last received unread e-mail count.

In yet another implementation, the user of the client device can be authenticated in two e-mail services on the client device, namely Google Mail and Yandex Mail. He is not presently on the web page of any of these e-mail services. However, a login cookie or another indication of the user's login credentials can be stored on the client device in association with the two e-mail services the user is logged into. The user starts typing a user-inputted string into omnibox of the user interface of the client device, such as an omnibox of a browser. Client device conducts analysis of the user-inputted string to determine if the user-inputted string can be deemed to be a trigger for displaying an unread e-mail count. If the client device recognizes the combination of characters as a trigger, the client device accesses files stored on the respective servers hosting respective Google Mail and Yandex Mail e-mail services. These files can be files in an XML or in any other suitable file format which can contain unread e-mail count. Locations of these files, as a non-limiting example, can be pre-programmed and stored on a non-transient computer usable information storage medium of a user device. After receiving from a server an indication of the unread e-mail count, the client device displays at least one of the received e-mail counts in the omnibox. For example, the client device can display two unread e-mail counts, corresponding to two e-mail accounts, namely to accounts with Google Mail and Yandex Mail e-mail services. However, one unread e-mail count can de displayed (for example, from Yandex Mail e-mail service only), if there is no unread messages in the user's mailbox on Google Mail e-mail service at the time and vice versa.

In another aspect, embodiments of the present technology provide client device having a non-transient computer usable information storage medium storing program instructions that when executed by a computer processor cause: receiving, by the client device from the user, the user being authenticated in an e-mail service on the client device, a trigger to display an unread e-mail count, the trigger having been entered into the omnibox; displaying the unread e-mail count in the omnibox.

In some embodiments, the omnibox comprises an address bar.

In some embodiments, the omnibox comprises a search bar.

In some embodiments, the omnibox comprises a combined search and address bar.

In some embodiments, the omnibox comprises: one of (i) the address bar, and (ii) the search bar, and (iii) the combined search and address bar; and a suggest menu in visual proximity to the respective one of the address bar, the search bar and the combined search and address bar. As a person skilled in the art would understand, the suggest menu can be a drop-down menu depending from the respective one of the address bar, the search bar and the combined search and address bar. However, the suggest menu can be any other type of menu.

In some embodiments, the non-transient computer usable information storage medium stores program instructions that when executed by the computer processor, prior to the displaying the unread e-mail count in the omnibox, further cause receiving from a server an indication of the unread e-mail count. This can be effected by access by the client device to a file stored on the respective server hosting an e-mail service. This file can be a file in an XML or any suitable file format which contains unread e-mail count. However, receiving from a server an indication of the unread e-mail count can be effected by receiving of the unread e-mail count sent to the client device by respective server.

In some embodiments, the non-transient computer usable information storage medium storing program instructions that when executed by the computer processor further cause, prior to the receiving from a server an indication of the unread e-mail count, sending to the server the request for the unread e-mail count.

In some implementations, the displaying the unread e-mail count is effected in the suggest menu. As a non-limiting example, the displaying the unread e-mail count can be effected in the suggest menu along with one or several search suggests, links to previously visited web pages, and the like. As a non limiting example, the unread e-mail count can be displayed in close proximity to the suggest associated with respective e-mail service. As a person skilled in the art would understand, the displaying of the unread e-mail count can be displaying of more than one e-mail count.

In some implementations, displaying the unread e-mail count comprises displaying a graphical object representative of the unread e-mail count. In some implementations, the graphical object can be an envelop sign, a flag sign, or it can be implemented in any other shape. As a non-limiting example, if the user is authenticated in three e-mail accounts, respectively three graphical objects of the same type can be displayed next to each respective unread e-mail count. For example, an image of a closed envelope can be displayed next to each unread count. In others implementations, a graphical object for each of the e-mail services can be different from the graphical objects of some or all of the other e-mail services.

In some implementations, some or all graphical objects can be omitted. For example, some of the unread e-mail notifications can be displayed with the associated graphical objects and others can be displayed without a respective graphical object. Furthermore, the graphical objects can be omitted altogether.

In some embodiments, the trigger to display the unread e-mail count comprises at least a portion of a word associated with the e-mail service. As a non-limiting example, trigger can comprise any character, for example letters “m”, “g”, and combinations of characters, for example “ma”, “mai”, “gmail” “i”, “in”, “inb”, “inbox”, “yahoo” “yandex”, “message”, “Nachrichten”, “ [symbol] ” and others. Combinations forming the trigger can consist of letters, numbers and other characters. Letters can be Latin, Cyrillic and others.

As person skilled in the art would understand, the user may have an intent to view the unread e-mail count and, as such, the user may deliberately enter a user-inputted string that the user knows will be recognized as the trigger to display the unread e-mail count into the omnibox. Alternatively, the user may not have the intent to get the unread e-mail count in the omnibox. In this case, depending on the content of the user-inputted string, the client device may still recognize characters entered into omnibox as the trigger to display the unread e-mail count. Both of such entries of characters (with or without the intent to have displayed the unread e-mail account), being recognized by the client device as the trigger to display the unread e-mail count, shall be considered to within the meaning of the term “trigger to display the unread e-mail count”.

As a non-limitative illustrative example of one of the implementations, the user of the client device can be authenticated in two e-mail services on the client device, namely Rambler Mail and Yandex Mail. He is not presently on the web page of any of these e-mail services. However, a login cookie or another indication of the user's login credentials can be stored on the client device in association with the two e-mail services the user is logged into. The user starts typing a user-inputted string into omnibox of the user interface of the client device, such as an omnibox of a browser. Client device conducts analysis of the user-inputted string to determine if the user-inputted string can be deemed to be a trigger for displaying an unread e-mail count. If the client device recognizes the combination of characters as a trigger, it sends the request for the unread e-mail count to servers hosting user's e-mail accounts where the user is presently authenticated, that is servers hosting Rambler Mail and Yandex Mail e-mail services. Then, in response, the servers send and the client device receives respective unread e-mail counts from respective servers and displays respective one or more e-mail counts in the omnibox.

In other implementations, the client device sends to the server an indication that the user is authenticated in an e-mail service on the client device, and does not send to the server the request for the unread e-mail count. The server then sends a notification to the client device, containing the unread e-mail count. This sending can be done repeatedly, for example, at a certain interval (for example, each 5 minutes, each 15 minutes, each 1 minute, etc). As an alternative, the server can send the notification to the client device upon new message, destined to the user, arriving to the server. In those implementations, once a trigger to display the unread e-mail count is received from the user, the trigger being substantially similar as has been described above, the client device displays the last received unread e-mail count.

In yet another aspect, implementations of the present technology provide a computer-implemented method for providing a user with an indication of an unread e-mail count on a client device, the client device having a user interface, the user interface having an omnibox, the method comprising: receiving from the client device by a server an indication that the user is authenticated in an e-mail service on the client device; transmitting, by a server, the indication of the unread e-mail count and instruction to display the indication in the omnibox.

In some implementations, the omnibox comprises an address bar.

In some implementations, the omnibox comprises a search bar.

In some implementations, the omnibox comprises a combined search and address bar.

In some implementations, the omnibox comprises: one of (i) the address bar, and (ii) the search bar, and (iii) the combined search and address bar; and a suggest menu in visual proximity to the respective one of the address bar, the search bar and the combined search and address bar. As a person skilled in the art would understand, the suggest menu can be a drop-down menu depending from the respective one of the address bar, the search bar and the combined search and address bar. However, the suggest menu can be any other type of menu, such as pop up menu, pop over menu, etc.

In some implementations, the method further comprising, before the transmitting, receiving from the client device a request for the unread e-mail count, the request sent by the client device responsive to the entry by the user into the omnibox of the client device characters recognized by the client device as the trigger to display the unread e-mail count.

In some implementations, the displaying the unread e-mail count is effected in the suggest menu. As a non-limiting example, the displaying the unread e-mail count can be effected in the suggest menu along with one or several search suggests, links to previously visited web pages, and the like. As a non limiting example, the unread e-mail count can be displayed in close proximity to the suggest associated with respective e-mail service. As a person skilled in the art would understand, the displaying of the unread e-mail count can be displaying of more than one e-mail count.

In some implementations, displaying the unread e-mail count comprises displaying a graphical object representative of the unread e-mail count. In some implementations, the graphical object can be an envelop sign, a flag sign, or it can be implemented in any other shape. As a non-limiting example, if the user is authenticated in three e-mail accounts, respectively three graphical objects of the same type can be displayed next to each respective unread e-mail count. For example, an image of a closed envelope can be displayed next to each unread count. In others implementations, a graphical object for each of the e-mail services can be different from the graphical objects of some or all of the other e-mail services. In some implementations, some or all graphical objects can be omitted. For example, some of the unread e-mail notifications can be displayed with the associated graphical objects and others can be displayed without a respective graphical object. Furthermore, the graphical objects can be omitted altogether.

In some implementations, the trigger to display the unread e-mail count comprises at least a portion of a word associated with the e-mail service. As a non-limiting example, trigger can comprise any character, for example letters “m”, “g”, and combinations of characters, for example “ma”, “mai”, “gmail” “i”, “in”, “inb”, “inbox”, “yahoo” “yandex”, “message”, “Nachrichten”, “ [symbol] ” and others. Combinations forming the trigger can consist of letters, numbers and other characters. Letters can be Latin, Cyrillic and others.

As person skilled in the art would understand, the user may have an intent to view the unread e-mail count and, as such, the user may deliberately enter a user-inputted string that the user knows will be recognized as the trigger to display the unread e-mail count into the omnibox. Alternatively, the user may not have the intent to get the unread e-mail count in the omnibox. In this case, depending on the content of the user-inputted string, the client device may still recognize characters entered into omnibox as the trigger to display the unread e-mail count. Both of such entries of characters (with or without the intent to have displayed the unread e-mail account), being recognized by the client device as the trigger to display the unread e-mail count, shall be considered to within the meaning of the term “trigger to display the unread e-mail count”.

e-mail count, shall be considered to be the trigger to display the unread e-mail count.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “a server”.

In the context of the present specification, “client device” is any computer hardware that is capable of running software appropriate to the relevant task at hand Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram showing a systems being an implementation of the present technology within a communications network environment.

FIG. 2 is a representation of a user interface displayed on the client device of the system of FIG. 1.

FIG. 3 is a block diagram of a method executed within the system of FIG. 1, depicting exchange of messages between various components of the system of FIG. 1 and the method step executed at the respective components of the system of FIG. 1., the method being executable in accordance with a non-limiting embodiment of the present technology

FIG. 4 is a block diagram of a method executed within the system of FIG. 1, depicting exchange of messages between various components of the system of FIG. 1 and the method step executed at the respective components of the system of FIG. 1., the method being executable in accordance with another non-limiting embodiment of the present technology.

### DETAILED DESCRIPTION

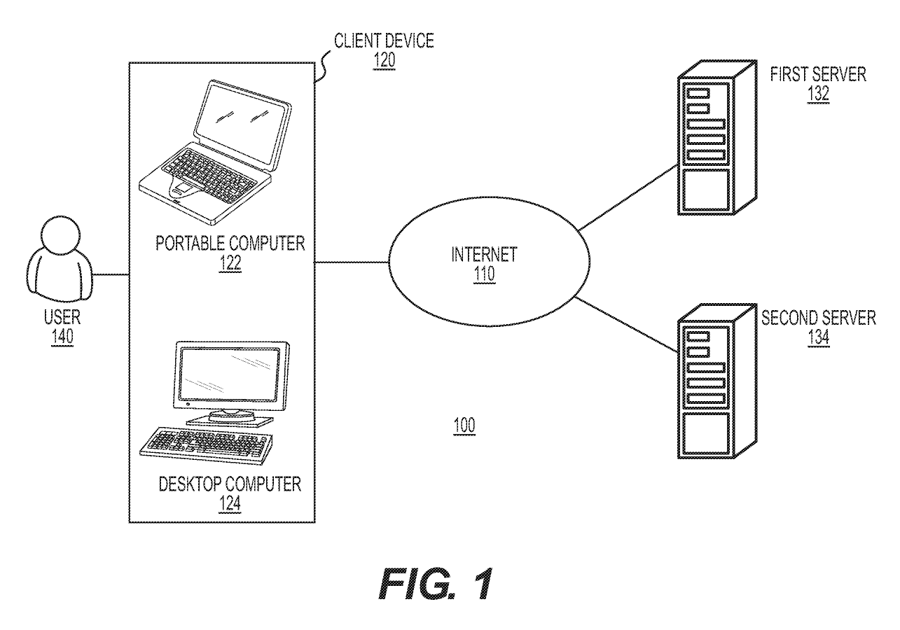

Referring to FIG. 1, there is shown a diagram of various networked computer systems 100 in communication with one another via a communications network 110. It is to be expressly understood that the various computer systems 100 are merely some implementations of the present technology. Thus, the description thereof that follows is intended to be only a description of illustrative examples of the present technology. This description is not intended to define the scope or set forth the bounds of the present technology. In some cases, what are believed to be helpful examples of modifications to computer systems 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the computer systems 100 may provide in certain instances simple implementations of the present technology, and that where such is the case they have been presented in this manner as an aid to understanding. As persons skilled in the art would understand, various implementations of the present technology may be of a greater complexity.

Referring to FIG. 1, a computer system 100 includes a plurality of devices in communication with each other via a communications network 110. In the present implementation, communications network 110 can be the Internet (and has been labeled as such in FIG. 1), but in other implementations communications network 110 can be any communications network capable of routing information between devices, such as LAN, WAN, and any other public or private network. Computer systems 100 include various types of computer hardware and software, each of which will be described in turn.

A client device 120 in this implementation can be a portable computer 122, a desktop computer 124, or any other client device, such as the client device having a user interface, the user interface having an omnibox, the client device connected through a computer network to an e-mail server.

A portable computer 122 in this implementation is a conventional notebook computer running the Microsoft™ Windows™ operating system and having the Yandex.Browser™ web browser program loaded and running thereon. In other implementations, portable computer 122 can be implemented on other types of hardware (e.g. notebook computers, laptop computers, tablet computers, netbook computers, etc.) and/or could be running other operating systems (e.g. Linux™, Mac OS X™, etc.) and/or other programs. In the depicted embodiment, the portable computer 122 can be connected to the Internet 110 in a conventional manner over a wireless communications link, such as WiFi or others. In other implementations, portable computer 122 could be connected to the Internet 110 over a conventional wired link (e.g. Ethernet).

A desktop computer 124 in this implementation is a conventional desktop computer running the Apple™ Macintosh™ operating system, and having the Yandex.Browser web browser program loaded and running thereon. Desktop computer 124 is connected to the Internet 110 in a conventional manner over a wired communications link, such as Ehternet. As was the case with portable computer 122, in other implementations, the hardware and/or software aspects of desktop computer 124 may vary in a fashion similar to described above.

A first server 132 in this implementation is an electronic mail server hosting Google Mail e-mail service. However, in other example embodiments, the particular mail server can be any type of mail server, such as an MDaemon, POP (Post Office Protocol or any version of POP such as POP3), Lotus Notes, Microsoft Exchange, and others). First server 132 in this implementation is connected to the Internet 110 in a conventional manner.

A second server 134 in this implementation is an electronic mail server hosting Yahoo Mail e-mail service. However, in other example embodiments, the particular mail server may vary in a fashion similar to described above. Second server 134 in this implementation is connected to the Internet 110 in a conventional manner.

A user 140 is the user of a client device 120, such as any one of the portable computer 122 and the desktop computer 124. The user 140 may be associated with any other client device, such as the client device having a user interface, the user interface having an omnibox, the client device connected through a computer network to an e-mail server.

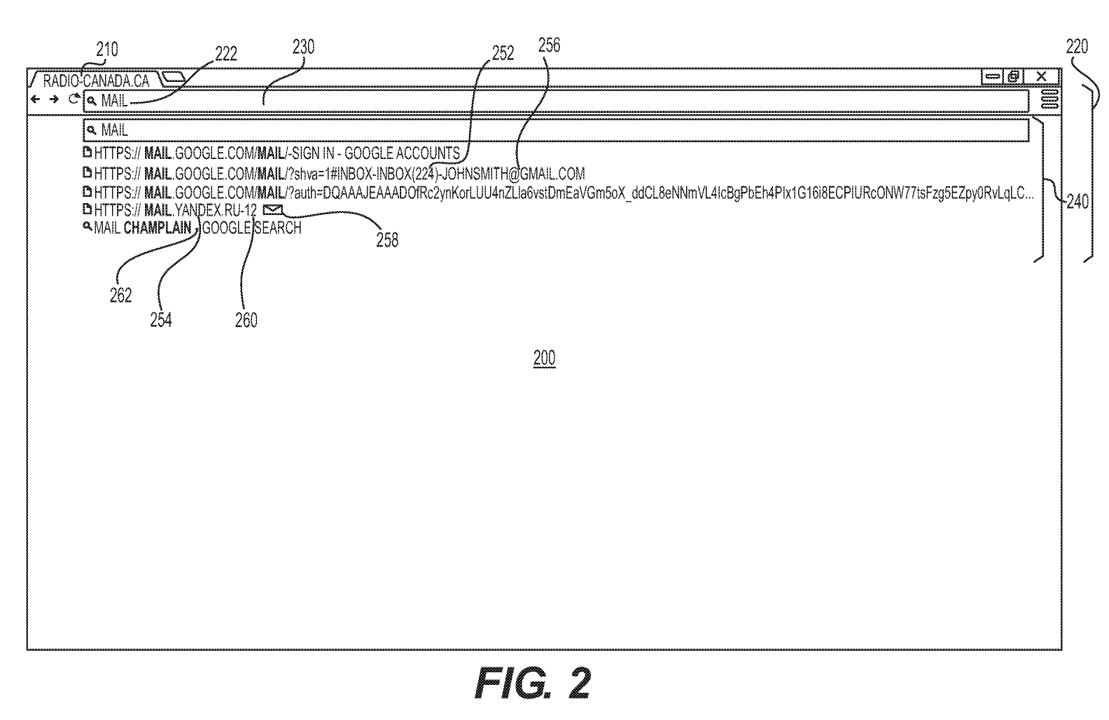

Referring to FIG. 2, there is shown a user interface 200 of an embodiment of the client device 120, which can be any one of the portable computer 122 or the desktop computer 124 or any other client device, such as the client device having a user interface, the user interface having an omnibox, the client device connected through a computer network to an e-mail server. FIG. 2 reflects one of many possible user interfaces and is intended to explain one of embodiments of the present technology and shall not be interpreted as a limiting a scope of the technology.

In the depicted embodiment, the user interface 200 of a client device 120 is implemented as an active web browser tab 210 of Google Chrome™ web browser.

The active web browser tab 210 comprise an omnibox 220, consisting of combined search and address bar 230 and of drop-down menu 240. The drop-down menu 240 appears when the user 140 types any character into combined search and address bar 230. Generally speaking, the purpose of the drop-down menu 240 is to display one or more suggests to the user, suggests being based on the entry that the user has started making into the drop-down menu 240. The drop-down menu 240 can of course contain a number of additional or alternative pieces of information. The general methods for generating content in the drop-down menu 240 are known in the art and, as such, will not be described in here at any length.

Client device 120 recognizes a combination of letters “mail” typed by the user 140 in the combined search and address bar 232 of the active web browser tab 210 as a trigger 222 to display an unread e-mail count. As a non-limiting example, the trigger 222 to display the unread e-mail count comprises at least a portion of a word associated with the e-mail service. As a non-limiting example, trigger can comprise any character, for example letters “m”, “g”, and combinations of characters, for example “ma”, “mai”, “gmail” “i”, “in”, “inb”, “inbox”, “yahoo” “yandex”, “message”, “Nachrichten”, “ [symbol] ” and others. Combinations forming the trigger can consist of letters, numbers and other characters. Letters can be Latin, Cyrillic, hieroglyphic and others.

Recognition of characters entered into the omnibox 220 as the trigger 222 to display the unread e-mail count can be effected by the client device 120 using keywords, the keywords stored on the storage medium of the client device 120, as well by using of sequences of characters which are present in the paths to the mailboxes previously visited by the user 140 during the present and previous sessions of the web browser, the paths stored in cookie files or in any other conventional manner. In some embodiments, the recognition of the trigger 222 can be executed by a browser application executed on the client device 120, the browser application that is responsible for generating and managing the user interface 200.

In response to receiving of the trigger 222 by the client device 120 from the user 140, the user 140 being authenticated in two e-mail services, as an example, the Yandex Mail and Google Mail on the client device 120, the trigger 222 to display an unread e-mail count, the trigger having been entered into the combined search and address bar 230, the client device 120 displays a first unread e-mail count 252 and a second unread e-mail count 260 along with a graphical object 258 representative of the unread e-mail count in the drop-down menu 240, as well as other results, including a search suggest 262. Even though, in the depicted embodiment only instance of the search suggest 262 is depicted, alternatively the search suggest 262 can be implemented as a plurality of search suggests. The first unread e-mail count 252 and the second unread e-mail count 260 appear next to respective indication of a first e-mail account 256 and the indication of a second e-mail account 254. The client device 120 may display any other information in the drop-down menu 240, as a non-limiting example, links to previously visited web pages. As a person skilled in the art would understand, the user 140 may be authenticated on e-mail services other than Yandex Mail or Google Mail. For the purposes of this description, the drop-down menu 240 together with the combined search and address bar 230 make part of omnibox 220. The number of e-mail services where the user is authenticated may vary. Furthermore, there may be any number of graphical objects representative of the unread e-mail count, not necessarily one as in this embodiment.

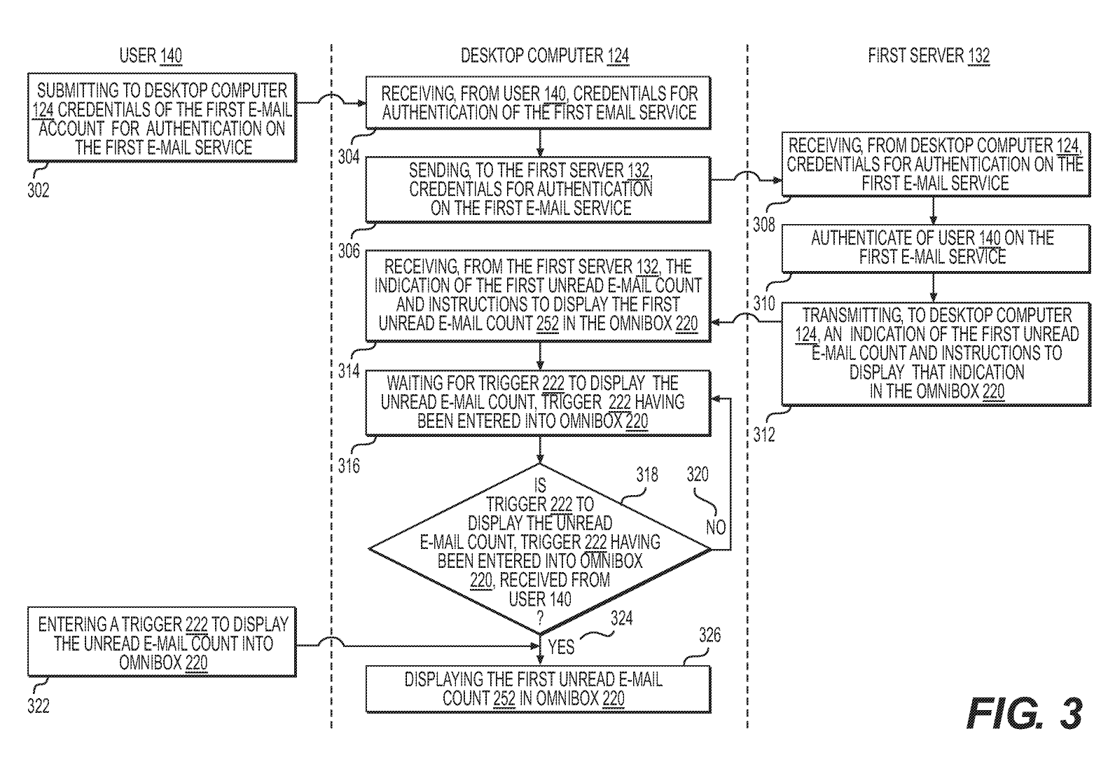

Referring to FIG. 3, there is shown a flow chart of a method for providing a user an indication of an unread e-mail count, the flow chart demonstrating interactions between the user 140, the desktop computer 124, and the first server 132 in one of implementations of the present technology. Within this embodiment, prior to user entering into the omnibox 220 of the desktop computer 124 characters recognized by the desktop computer 124 as the trigger 222 to display the unread e-mail count, the first server 132 sends a notification containing the first unread e-mail count to the desktop computer 124. The desktop computer 124 waits for the user 140 input and displays the unread e-mail count responsive to recognition of the input as trigger 222 to display the unread e-mail count. This implementation will be described below in more details.

At step 302, the user 140 submits to the desktop computer 124 and the desktop computer 124 at step 304 receives credentials of the first e-mail account for authentication on the first e-mail service. At step 306, the desktop computer 124 sends and the first server 132 at step 308 receives the credentials of the first e-mail account for authentication on the first e-mail service. At step 310, the first server 132 effects authentication of the user 140 for the first e-mail service. Authentication shall be interpreted in a broad sense: as a person skilled in the art would understand, the server can perform other usual steps like authorization and others.

At step 312, recalling that the user 140 is being authenticated in the first e-mail service, the first server 132 transmits to the desktop computer 124, and the desktop computer 124 receives at step 314, an indication of the first unread e-mail count and an instruction to display the indication in the omnibox 220. However, in other implementations, the server can send the first unread e-mail count, but not instruction to display that indication in the omnibox 220. In this case, in response to entering by the user 140 into the omnibox 220 of the desktop computer 124 characters recognized by the desktop computer 124 as the trigger 222 to display the unread e-mail count, the client device 120 itself (which can be, as a non limiting example, the desktop computer 124) can produce instruction.

As a non limiting example, at step 312, the first server 132 can transmit to the desktop computer 124 the indication of the first unread e-mail count as an XML file.

As a person skilled in the art would understand, an indication of the first unread e-mail count may be plurality of indications of the first unread e-mail count. The first server 132 can send unread e-mail count repeatedly, for example, at a certain interval (for example, each 5 minutes, each 15 minutes, each 1 minute, etc). As an alternative, the server can send unread e-mail count to the client device upon new message, destined to the user, arriving to the server. Irrespective of how the first server 132 sends the updated e-mail count information, generally speaking, every next indication of the unread e-mail count comprises an updated information on the unread e-mail count vis-a-vis a previously sent indication of the unread e-mail count. For example, the first server 132 sends an indication of the first unread e-mail count to the desktop computer 124. At a second instance of time, after the first instance of time, the first server 132 sends an indication of a second unread e-mail count. The second unread e-mail count can be considered to be an update on the first unread e-mail count. The second unread e-mail count can be incrementally increased (if new e-mails have arrived) compared to the first unread e-mail count or can be the same (if no new e-mails have arrived).

At step 316, the desktop computer 124 waits for the trigger 222 to display the unread e-mail count, the trigger 222 having been entered into omnibox 220 by the user 140. As a non-limiting example, the trigger 222 to display the unread e-mail count comprises at least a portion of a word associated with the e-mail service. As a non-limiting example, trigger can comprise any character, for example letters “m”, “g”, and combinations of characters, for example “ma”, “mai”, “gmail” “i”, “in”, “inb”, “inbox”, “yahoo” “yandex”, “message”, “Nachrichten”, “ [symbol] ” and others. Combinations forming the trigger can consist of letters, numbers and other characters. Letters can be Latin, Cyrillic, hieroglyphic and others. Recognition of characters entered into the omnibox 220 as the trigger 222 to display the unread e-mail count can be effected by the desktop computer 124 using keywords, the keywords stored on the storage medium of the desktop computer 124, as well by using of sequences of characters which are present in the paths to the mailboxes previously visited by the user 140 during the present and previous sessions of the web browser, the paths stored in cookie files or in any other conventional manner.

At step 318, the desktop computer 124 verifies whether the trigger 222 to display the unread e-mail count has been entered into the omnibox 220 is entered by the client 140. If answer is negative (step 320), the desktop computer 124 continues waiting (step 316) until affirmative answer (step 324) is received.

At step 322, the user 140 enters a user-inputted string, which is recognized as the trigger 222 to display the unread e-mail count into the omnibox 220. As person skilled in the art would understand, the user 140 may have an intent to view the unread e-mail count and, as such, the user 140 may deliberately enter a user-inputted string that the user 140 knows will be recognized as the trigger 222 to display the unread e-mail count into the omnibox 220. Alternatively, the user 140 may not have the intent to get the unread e-mail count in the omnibox 220. In this case, depending on the content of the user-inputted string, the desktop computer 124 may still recognize characters entered into omnibox 220 as the trigger 222 to display the unread e-mail count. Both of such entries of characters (with or without the intent to have displayed the unread e-mail account), being recognized by the desktop computer 124 as the trigger 222 to display the unread e-mail count, shall be considered to within the meaning of the term “trigger 222 to display the unread e-mail count”.

At step 324, the desktop computer 124 receives the trigger 222 to display the unread e-mail count having been entered into the omnibox 220.

At step 326, the desktop computer 124 displays the first unread e-mail count 252 in the omnibox 220. The method then terminates.

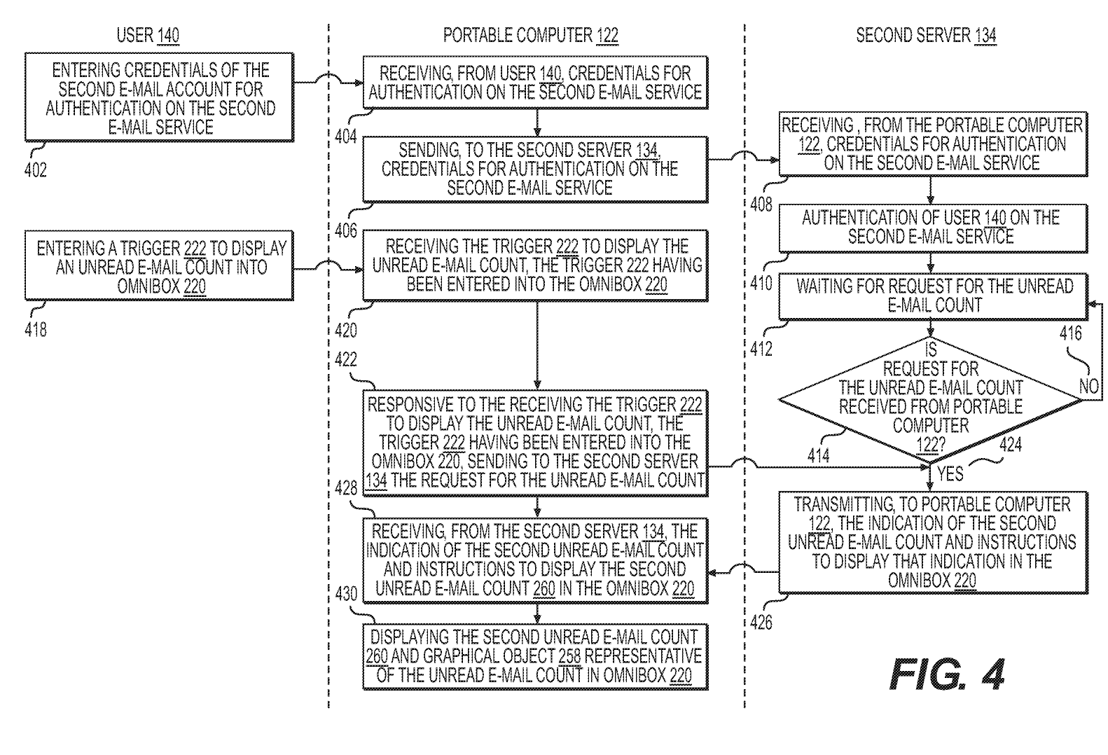

Referring to FIG. 4, there is shown a flow chart of a method for providing a user an indication of an unread e-mail count, the flow chart demonstrating interactions between the user 140, the portable computer 122, and the second server 134 in one of implementations of the present technology. Within this embodiment, the second server 134 sends a notification containing the second unread e-mail count to portable computer 122, responsive to request for the unread e-mail count sent to the second server 134 by the portable computer 122, the portable computer 122 responsive in turn to the entry by the user 140 into the omnibox 220 of the portable computer 122 characters recognized by the portable computer 122 as the trigger 222 to display the second unread e-mail count. This implementation will be described below in more details.

At step 402, the user 140 of the portable computer 122 enters credentials of the second e-mail account for authentication on the second e-mail service, and at step 404 the portable computer 122 receives credentials of the second e-mail account for authentication on the second e-mail service.

At step 406, the portable computer 122 sends to the second server 134, and the second server 134, at step 408, receives the credentials of the second e-mail account for authentication on the second e-mail service.

At step 410, the second server 134 effects authentication of the user 140. Authentication shall be interpreted in a broad sense: as a person skilled in the art would understand, the server can perform other usual steps like authorization and others.

At step 412, the second server 134 waits for request for the unread e-mail, the request to be sent by the portable computer 122, the portable computer 122 responsive to the entry by the user 140 into the omnibox 220 of the portable computer 122 characters recognized by the portable computer 122 as the trigger 222 to display the second unread e-mail count.

At step 414, the second server 134 verifies whether the request for the unread e-mail, the request to be sent by the portable computer 122, the portable computer 122 responsive to the entry by the user 140 into the omnibox 220 of the portable computer 122 characters recognized by the portable computer 122 as the trigger 222 to display the second unread e-mail count, is received from the portable computer 122. If answer is negative (step 416), the second server 134 continues waiting (step 412) until affirmative answer (step 424) is received.

At step 418, the user 140 enters a user-inputted string that can be recognized the trigger 222 to display the unread e-mail count into the omnibox 220. As person skilled in the art would understand, the user 140 may have an intent to view the unread e-mail count and, as such, the user 140 may deliberately enter a user-inputted string that the user 140 knows will be recognized as the trigger 222 to display the unread e-mail count into the omnibox 220. Alternatively, the user 140 may not have the intent to get the unread e-mail count in the omnibox 220. In this case, depending on the content of the user-inputted string, the portable computer 122 may still recognize characters entered into omnibox 220 as the trigger 222 to display the unread e-mail count. Both of such entries of characters (with or without the intent to have displayed the unread e-mail account), being recognized by the desktop computer 124 as the trigger 222 to display the unread e-mail count, shall be considered to within the meaning of the term “trigger 222 to display the unread e-mail count”.

At step 420, the portable computer 122 receives the trigger 222 to display the unread e-mail count.

At step 422, responsive to the receiving the trigger 222 to display the unread e-mail count, the trigger 222 having been entered into the omnibox 220, the portable computer 122 sends to the second server 134 the request for the unread e-mail count, and at step 424, the second server 134 receives the request for the unread e-mail count.

At step 426, in response to receiving the request for the unread e-mail count, the second server 134 transmits to the portable computer 122 an indication of the second unread e-mail count and an instruction to display the indication in the omnibox 220.

At step 428, the portable computer 122 receives from the second server 134 the indication of the second unread e-mail count and the instruction to display the second unread e-mail count 260 in the omnibox 220.

At step 430, the portable computer 122 displays the second unread e-mail count 260 and a graphical object 258 representative of the unread e-mail count in the omnibox 220. It should be understood that in other embodiments the client device 120, which can be the portable computer 122, can display, along with the second unread e-mail count 260 and a graphical object 258 representative of the unread e-mail count, any other results, as non limiting example, search suggest 262, which can be a plurality of search suggests, and links to previously visited web pages. The method then terminates.

Even though the above described methods of FIG. 3 and FIG. 4 each have been described with reference to generating only a single unread e-mail count, the method described above can be applicable to generating unread e-mail counts for more than one e-mail service in a single instance of the omnibox 220. Also, within those embodiments, where more than one unread e-mail count is presented in the omnibox 220, the methods used for generating the respective unread e-mail counts need not to be limited to those described in FIG. 3 or FIG. 4. On the contrary, some of the unread e-mail counts can be generated using the method of FIG. 3 and some can be generated using the methods of FIG. 4. Needless to say, all of the multiple unread e-mail counts can be generated using one or the other of the method of FIG. 3 or FIG. 4.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for providing a user with an indication of an unread e-mail count of an e-mail service on a client device, the client device displaying a web page, the web page not being associated with the e-mail service, the web page including an omnibox, the omnibox including an address bar, the method comprising:
receiving, by the client device from the user, the user being authenticated in the e-mail service on the client device, a trigger to display the unread e-mail count, the trigger having been entered into the address bar, the trigger including at least a portion of a word indicative of at least one of a keyword associated with the email service and a previously visited path associated with the e-mail service;
displaying the unread e-mail count in the omnibox.

2. The method of claim 1, further comprising receiving from a server, prior to said displaying, an indication of the unread e-mail count.

3. The method of claim 1, further comprising, after receiving by the client device from the user, the user being authenticated in the e-mail service on the client device, a trigger to display the unread e-mail count, the trigger having been entered into the address bar, the trigger including at least a portion of a word indicative of at least one of a keyword associated with the email service and a previously visited path associated with the e-mail service, and prior to said displaying:
sending to the server the request for the unread e-mail count;
receiving, from the server, the indication of the unread e-mail count.

4. The method of claim 2, the unread e-mail count being a first unread e-mail count, the method further comprising: receiving a second unread e-mail count at a point of time after said receiving of the trigger and wherein said displaying the unread e-mail count in the omnibox comprises one of displaying the first unread e-mail count and second unread e-mail count.

5. The method of claim 1, wherein the omnibox comprises one of (i) an address bar, and (ii) a combined search and address bar.

6. The method of claim 5, further comprising a suggest menu in visual proximity to the respective one of the address bar and the combined search and address bar.

7. The method of claim 6, wherein the suggest menu is a drop-down menu depending from the respective one of the address bar and the combined search and address bar.

8. The method of claim 6, wherein said displaying the unread e-mail count effects is effected in the suggest menu.

9. The method of claim 1, wherein displaying the unread e-mail count comprises displaying a graphical object representative of the unread e-mail count.

10. (canceled)

11. A client device having a display showing a web page, the web page not being associated with an e-mail service, the web page including an omnibox, the omnibox including an address bar, the client device further having a non-transient computer usable information storage medium storing program instructions that when executed by a computer processor cause:
receiving, by the client device from the user, the user being authenticated in the e-mail service on the client device, a trigger to display an unread e-mail count, the trigger having been entered into the address bar, the trigger including at least a portion of a word indicative of at least one of a keyword associated with the email service and a previously visited path associated with the e-mail service;
displaying the unread e-mail count in the omnibox.

12. The client device of claim 11, wherein the non-transient computer usable information storage medium storing program instructions that when executed by the computer processor further cause, prior to said displaying, receiving from a server an indication of the unread e-mail count.

13. The client device of claim 11, wherein the non-transient computer usable information storage medium storing program instructions that when executed by the computer processor further cause, after receiving by the client device from the user, the user being authenticated in the e-mail service on the client device, a trigger to display the unread e-mail count, the trigger having been entered into the address bar, the trigger including at least a portion of a word indicative of at least one of a keyword associated with the email service and a previously visited path associated with the e-mail service, and prior to said displaying:
sending to the server the request for the unread e-mail count;
receiving, from the server, the indication of the unread e-mail count.

14. The client device of claim 12, the unread e-mail count being a first unread e-mail count, the method further comprising: receiving a second unread e-mail count at a point of time after said receiving of the trigger and wherein said displaying the unread e-mail count in the omnibox comprises one of displaying the first unread e-mail count and second unread e-mail count.

15.-20. (canceled)

21. A computer-implemented method for providing a user with an indication of an unread e-mail of an e-mail service on a client device, the client device displaying a web page, the web page not being associated with the e-mail service, the web page including an omnibox, the method comprising:
receiving from the client device by a server an indication that the user is authenticated in the e-mail service on the client device;
transmitting, by a server, the indication of the unread e-mail count and an instruction to display said indication in the omnibox.

22. The method of claim 21, wherein transmitting, by a server, the indication of the unread e-mail count and an instruction to display said indication in the omnibox, is repetitive transmitting, by a server, the indication of the unread e-mail count and an instruction to display said indication in the omnibox.

23. The method of claim 21, further comprising, before the transmitting, receiving from the client device a request for the unread e-mail count, the request being sent by the client device responsive to a trigger having been entered into an address bar of the omnibox, the trigger including at least a portion of a word indicative of at least one of a keyword associated with the email service and a previously visited path associated with the e-mail service.

24. The method of claim 21, wherein the omnibox comprises one of (i) an address bar, and (ii) a combined search and address bar.

25. The method of claim 24, further comprising a suggest menu in visual proximity to the respective one of the address bar and the combined search and address bar.

26. The method of claim 25, wherein the suggest menu is a drop-down menu depending from the respective one of the address bar and the combined search and address bar.

27. The method of claim 25, wherein said displaying the unread e-mail count is effected in the suggest menu.

28. The method of claim 21, wherein displaying the unread e-mail count comprises displaying a graphical object representative of the unread e-mail count.

29. (canceled)
